(19) United States
(12) Patent Application Publication
(10) Pub. No.: US 2026/0180911 A1
(43) Pub. Date: Jun. 25, 2026

(54) USER EQUIPMENT HAVING IMPROVED POWER EFFICIENCY AND SYSTEM INCLUDING THE SAME

(71) Applicant: SAMSUNG ELECTRONICS CO., LTD., Suwon-si (KR)

(72) Inventors: Seungjin CHOI, Suwon-si (KR); Yangsoo KWON, Suwon-si (KR); Junho LEE, Suwon-si (KR); Woongjae HAN, Suwon-si (KR); Jonggun MOON, Suwon-si (KR); Yoojin CHOI, Suwon-si (KR)

(73) Assignee: SAMSUNG ELECTRONICS CO., LTD., Suwon-si (KR)

(21) Appl. No.: 19/310,500

(22) Filed: Aug. 26, 2025

(30) Foreign Application Priority Data
Dec. 20, 2024 (KR) 10-2024-0192965

(51) Int. Cl. H04L 47/2441; H04L 5/00

(52) U.S. Cl. CPC H04L 47/2441; H04L 5/0048

(57) ABSTRACT

Provided are a user equipment with improved power efficiency and a system including the same. The user equipment includes a radio frequency (RF) circuit configured to receive a message from a base station, a memory storing a spectral efficiency set, the spectral efficiency set including spectral efficiency candidates corresponding to a number of reception antennas, and a processor configured to obtain traffic information from the message, calculate a required spectral efficiency based on the traffic information by using an artificial intelligence model, compare the required spectral efficiency with the spectral efficiency set, and determine a first spectral efficiency candidate with a first number of reception antennas according to a result of comparing the required spectral efficiency with the spectral efficiency set.

### CROSS-REFERENCE TO RELATED APPLICATION

This application is based on and claims priority under 35 U.S.C. § 119 to Korean Patent Application No. 10-2024-0192965, filed on Dec. 20, 2024, in the Korean Intellectual Property Office, the disclosure of which is incorporated by reference herein in its entirety.

### BACKGROUND

The disclosure relates to a user equipment with improved power efficiency and a system including the same.

To achieve efficient power consumption of a user equipment in a 3rd Generation Partnership Project (3GPP) wireless communication system, in an idle mode in which no data transmission occurs, the user equipment may selectively execute an operation or may change to an operation with low power consumption. Also, in a connected mode in which data transmission occurs, when a communication channel is in good condition or a required transmission rate is low, the user equipment may change to an operation with low power consumption.

However, when an operation selected by the user equipment is unsuitable for a transmission and reception pattern of the user equipment, the transmission rate or performance of the user equipment may be degraded. Therefore, it may be necessary to identify a transmission and reception pattern of the user equipment and select an operation that is suitable for the identified transmission and reception pattern.

### SUMMARY

According to an aspect of the disclosure, there is provided a user equipment including: a radio frequency (RF) circuit configured to receive a message from a base station; a memory storing a spectral efficiency set, the spectral efficiency set including spectral efficiency candidates corresponding to a number of reception antennas; and a processor configured to: obtain traffic information from the message, calculate a required spectral efficiency based on the traffic information by using an artificial intelligence model, compare the required spectral efficiency with the spectral efficiency set, and determine a first spectral efficiency candidate with a first number of reception antennas according to a result of comparing the required spectral efficiency with the spectral efficiency set.

According to another aspect of the disclosure, there is provided a user equipment including: a radio frequency (RF) circuit configured to receive a message from a base station; and a processor configured to: obtain traffic information of the user equipment from the message, determine a traffic class based on the traffic information by using an artificial intelligence model, and generate user equipment assistance information (UAI) based on the traffic class.

According to another aspect of the disclosure, there is provided a communication system including: a base station; and a user equipment configured to: receive a message from the base station, obtain traffic information from the message, determine a traffic class based on the traffic information by using an artificial intelligence model, and generate user equipment assistance information (UAI) based on the traffic class.

### BRIEF DESCRIPTION OF DRAWINGS

Embodiments will be more clearly understood from the following detailed description taken in conjunction with the accompanying drawings in which:

FIG. 1 is a diagram illustrating a communication system according to an embodiment;

FIG. 2 is a block diagram illustrating a user equipment (UE) according to an embodiment;

FIG. 3 is a diagram illustrating an artificial intelligence (AI) model according to an embodiment;

FIGS. 4A and 4B are diagrams illustrating spectral efficiency (SE) and SE candidates according to an embodiment;

FIG. 5 is a diagram illustrating an AI model according to another embodiment;

FIG. 6 is a diagram illustrating an AI model according to another embodiment;

FIG. 7 is a diagram illustrating fields included in UE assistance information (UAI), according to an embodiment;

FIG. 8 is a diagram illustrating an AI model according to another embodiment;

FIG. 9 is a diagram illustrating an AI model according to another embodiment;

FIG. 10 is a diagram illustrating a data burst pattern according to an embodiment;

FIG. 11 is a diagram illustrating an AI model according to another embodiment;

FIG. 12 is a diagram illustrating the structure of a neural network according to an embodiment;

FIG. 13 is a flowchart illustrating a method of determining the number of reception antennas, according to an embodiment;

FIG. 14 is a flowchart illustrating a method of generating UAI, according to an embodiment;

FIG. 15 is a flowchart illustrating a method of executing a low power mode (LPM), according to an embodiment; and

FIG. 16 is a block diagram illustrating a UE according to another embodiment.

### DETAILED DESCRIPTION

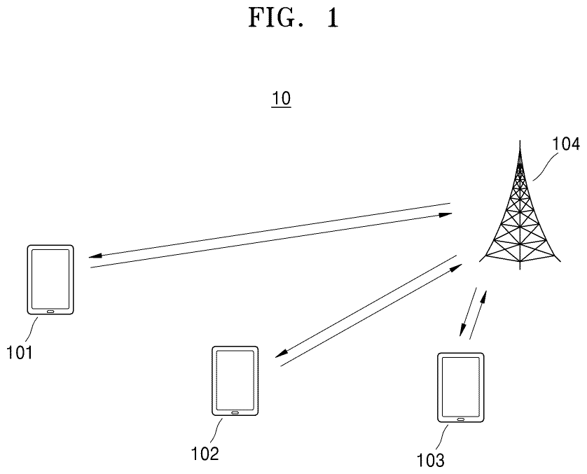

FIG. 1 is a diagram illustrating a communication system according to an embodiment.

Referring to FIG. 1, a wireless communication system 10 may include a base station (BS) 104 and one or more user equipments (UEs). For example, the one or more user equipments may include a first user equipment 101, a second user equipment 102, and a third user equipment 103. However, the disclosure is not limited thereto, and as such, the number of user equipments may be different than three.

The BS 104 may have coverage that is defined as a certain geographic area based on a distance at which a signal is transmittable. The BS 104 may communicate with the UEs 101 to 103. For example, the BS 104 may be an entity that allocates communication network resources to the UEs 101 to 103. According to an embodiment, the BS 104 may include, but is not limited to, at least one of a cell, a BS, a NodeB (NB), an eNodB (eNB), a next generation radio access network (NG RAN), a wireless access unit, a BS controller, a node on a network, a gNodeB (gNB), a transmission and reception point (TRP), and a remote radio head (RRH).

The UEs 101 to 103 may each be an entity that communicates with the BS 104. For example, the UEs 101 to 103 may each be referred to as a node, a UE, a next generation UE (NG UE), a mobile station (MS), a mobile equipment (ME), a device, or the like. According to an embodiment, communication may also be performed between the UEs 101 to 103.

According to an embodiment, the UEs 101 to 103 may include, but is not limited to, at least one of a smartphone, a tablet personal computer (PC), a mobile phone, a video phone, an e-book reader, a desktop PC, a laptop PC, a netbook computer, a personal digital assistant (PDA), a portable multimedia player (PMP), an MP3 player, medical equipment, a camera, and a wearable device. Also, the UEs 101 to 103 may include at least one of a television, a digital video disk (DVD) player, an audio device, a refrigerator, an air conditioner, a vacuum cleaner, an oven, a microwave oven, a washing machine, an air purifier, a set-top box, a home automation control panel, a security control panel, a media box (e.g., Samsung HomeSync™, Apple TV™, or Google TV™), a game console (e.g., Xbox™ or PlayStation™), an electronic dictionary, an electronic key, a camcorder, and an electronic picture frame. Also, the UEs 101 to 103 may include at least one of various types of medical equipment (e.g., various types of portable medical measuring equipment (a blood glucose meter, a heart rate meter, a blood pressure meter, a body temperature meter, or the like), magnetic resonance angiography (MRA), magnetic resonance imaging (MRI), computed tomography (CT), a photographic device, an ultrasonic device, or the like), a navigation device, a global navigation satellite system (GNSS), an event data recorder (EDR), a flight data recorder (FDR), an automotive infotainment device, marine electronic equipment (e.g., a marine navigation device, a gyrocompass, or the like), avionics, security equipment, a vehicle head unit, an industrial or household robot, a drone, an automatic teller machine (ATM) of a financial institution, point of sales (POS) in a store, and an Internet of Things device (e.g., a light bulb, various types of sensors, a sprinkler device, a fire alarm, a thermostat, a street lamp, a toaster, exercise equipment, a hot water tank, a heater, a boiler, or the like). Furthermore, the UEs 101 to 103 may include various types of multimedia systems capable of performing communication functions.

According to an embodiment, the UE 101 may receive a message from the BS 104 through a downlink. For example, the UE 101 may receive a message from the BS 104 through a physical downlink control channel (PDCCH) or a physical downlink shared control channel (PDSCH).

The UE 101 may obtain traffic information from the received message. The traffic information may include, but is not limited to, at least one of a packet size, a packet arrival interval, the number of packets, a transport packet size, a modulation and coding scheme (MCS), and the number of resource blocks (RBs). The traffic information may also include, but is not limited to, a PDSCH allocation pattern, a code block (CB) size, the number of CBs, a transport block (TB) size, the number of layers, a downlink control information (DCI) ratio, initial transmission/retransmission indication, and the like. In addition, the traffic information may include a rank indicator (RI), a block error rate (BLER), a channel quality indicator (CQI), a global cell identifier (ID), a physical cell ID, a band, a bandwidth, a reference signal received power (RSRP), a reference signal received quality (RSRQ), a received signal strength indicator (RSSI), a signal-to-interference-plus-noise ratio (SINR), a precoding matrix indicator (PMI), a modulation order, a transmit power, a Doppler frequency, a delay spread, and the like.

According to an embodiment, the UE 101 may determine a traffic class based on the obtained traffic information. For example, the UE 101 may determine a traffic class based on the obtained traffic information by using an artificial intelligence (AI) model. For example, the traffic class may include a class with low delay and high throughput, a class with low delay and low throughput, a class with high delay and high throughput, and a class with high delay and low throughput. For example, the low delay may mean lower than a reference delay, the high delay may mean higher than a reference delay, the low throughput may mean lower than a reference throughput, the high throughput may mean higher than a reference throughput. However, the disclosure is not limited thereto, and as such, the traffic class may include a class with other features. According to an embodiment, the traffic class may be referred to as a traffic group.

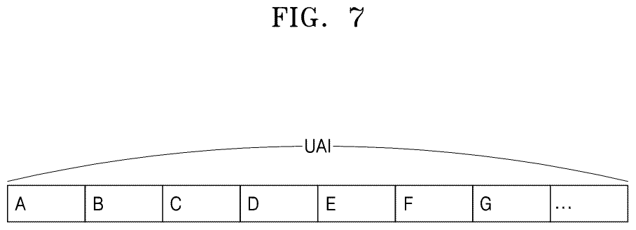

According to an embodiment, the UE 101 may generate UE assistance information (UAI) based on the determined traffic class. The term “UAI” may be as defined in the TS 38.331 standard specification. The UAI may include at least one of a field for configuring discontinuous reception (DRX) parameters, a field for configuring the maximum total bandwidth, a field for configuring the maximum number of component carriers, a field for configuring the maximum number of multiple-input multiple-output (MIMO) layers, a field for configuring a radio resource control (RRC) state, a field for configuring an activation state of a secondary cell, and a field for configuring radio resource management (RRM) measurements. The above-described fields are only examples, and the disclosure is not limited thereto. The fields included in the UAI will be described in detail below with reference to FIG. 7.

The UE 101 may notify the BS 104 of a UAI reporting function, and may transmit an RRC message including the generated UAI to the BS 104 through an uplink. For example, the UE 101 may transmit the RRC message including the generated UAI to the BS 104 through a physical uplink shared channel (PUSCH).

The BS 104 may communicate with the UE 101 based on the UAI of the UE 101, thereby reducing the power consumption of the UE 101. For example, the power consumption of the UE 101 may be reduced by transmitting, to the BS 104, UAI for configuring a DRX period to be long or extending a DRX deactivation time. In another example, the power consumption of the UE 101 may be reduced by transmitting, to the BS 104, UAI for configuring the UE 101 to an RRC idle state or simplifying RRM measurements.

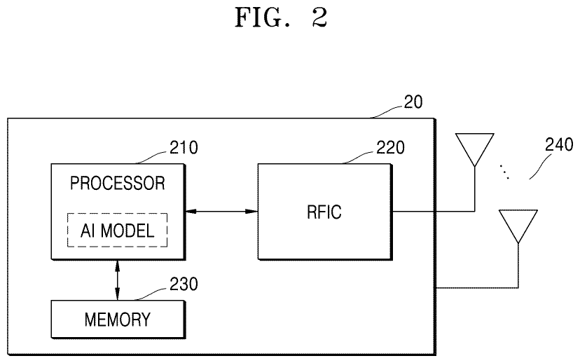

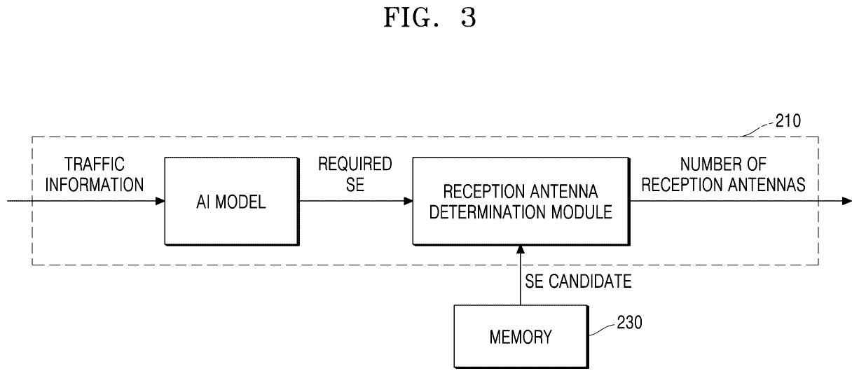

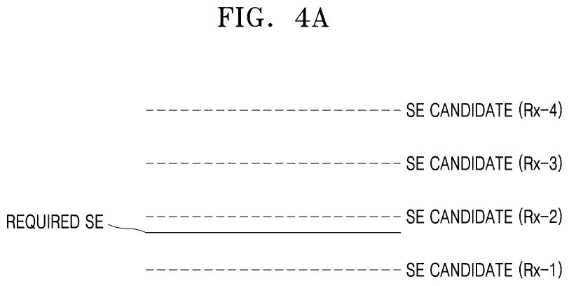

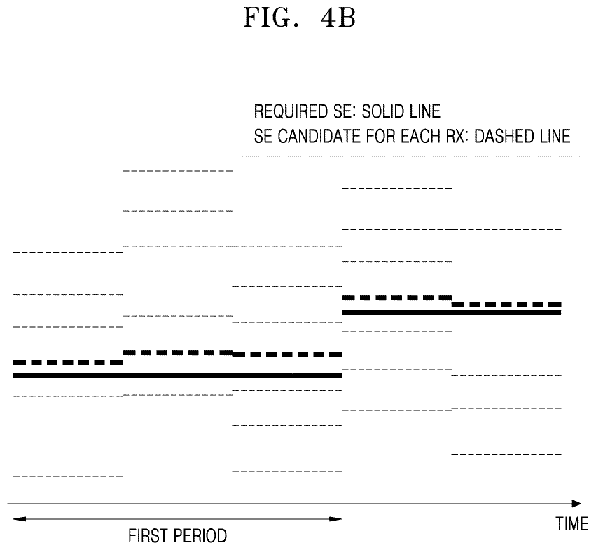

FIG. 2 is a block diagram illustrating a UE according to an embodiment. FIG. 3 is a diagram illustrating an AI model according to an embodiment. FIGS. 4A and 4B are diagrams illustrating spectral efficiency (SE) and SE candidates according to an embodiment.

Referring to FIG. 2, a UE 20 may include a processor 210, a radio frequency integrated circuit (RFIC) 220, a memory 230, and a plurality of antennas 240. However, the disclosure is not limited thereto, and as such, according to another embodiment, the UE 20 may include one or more other components. The processor 210 may control the RFIC 220, and may be configured to implement an operation method and operation flowcharts of the UE 20 of the disclosure. The UE 20 may include a plurality of antennas 240, and the RFIC 220 may transmit and receive wireless signals through one or more antennas. According to an embodiment, at least some of the plurality of antennas 240 may correspond to a transmission antenna. For example, the transmission antenna may transmit a wireless signal to an external device other than the UE 20. According to an embodiment, at least some of the remaining antennas 240 may correspond to a reception antenna. For example, the reception antenna may receive a wireless signal from the external device.

According to an embodiment, the RFIC 220 may be configured to receive a message from a BS (e.g., the BS 104 in FIG. 1), and the memory 230 may store an SE set. The SE set may include SE candidates corresponding to the number of reception antennas. The term “spectral efficiency” may represent the total amount of data that may be transmitted per unit bandwidth, and in the disclosure, the terms “spectral efficiency” and “throughput” may be interchangeably used.

In an example case in which the UE 20 includes four reception antennas, the SE set may include an SE candidate corresponding to one reception antenna, an SE candidate corresponding to two reception antennas, an SE candidate corresponding to three reception antennas, and an SE candidate corresponding to four reception antennas.

In another example, the SE set may include SE candidates corresponding to the number of reception antennas and a rank assigned from the BS. In an example case in which the assigned rank is 2 and the number of reception antennas is 4, the SE set may include an SE candidate corresponding to the rank of 2 and the number of reception antennas of 2, an SE candidate corresponding to the rank of 2 and the number of reception antennas of 3, and an SE candidate corresponding to the rank of 2 and the number of reception antennas of 4.

According to an embodiment, values of the SE candidates included in the SE set may be manually configured or experimentally configured in the UE 20. The SE candidates may be stored in the memory 230. For example, the SE candidates with configured the values may be stored in the memory 230 in the form of a lookup table. In another example, the processor 210 may obtain reference signal information from a message received from the BS, and may update the SE candidates based on the obtained reference signal information by using an AI model. The process of updating the SE candidates will be described in detail below with reference to FIG. 5.

The AI model may be embedded in the processor 210. While the AI model is shown as being embedded in the processor 210 in an embodiment, this is only an example, and the disclosure is not limited thereto. According to an embodiment, an AI model installed externally to the UE 20 may be used, and communication with the externally installed AI model may be performed through a network. Data and/or computational models required for the AI model to perform computations may be stored in the memory 230.

Referring to FIG. 3, the processor 210 may obtain traffic information from a received message, and may calculate a required SE based on the obtained traffic information. For example, the processor 210 may calculate the required SE based on the obtained traffic information by using the AI model. According to an embodiment, the required SE may indicate an SE required for a service (e.g., a current service) of the UE. In addition, the processor 210 may determine a delay value based on the obtained traffic information by using the AI model.

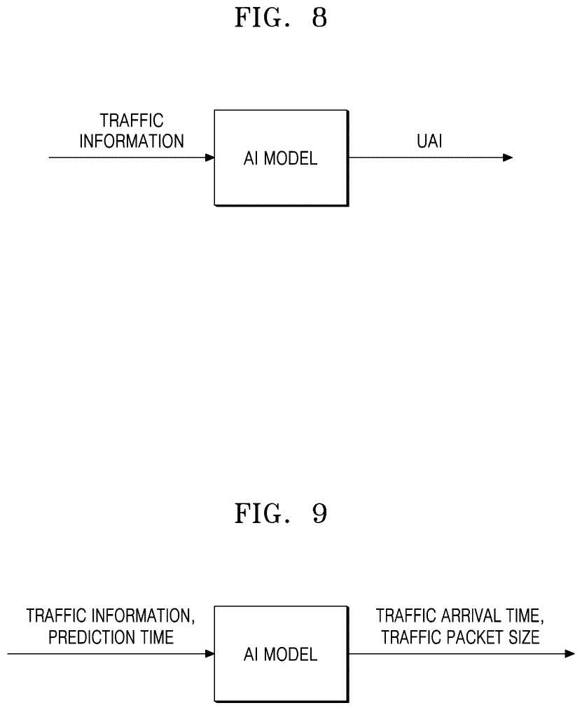

According to an embodiment, the processor 210 may determine a traffic class based on the required SE and the determined delay value, and may generate UAI based on the determined traffic class. The process of generating the UAI will be described in detail below with reference to FIG. 8.

According to an embodiment, the processor 210 may compare the required SE with the SE candidates stored in the memory 230 and may determine the number of reception antennas according to a comparison result. For example, the processor 210 may include a reception antenna determination module, which receives the required SE and compares the required SE with the SE candidates stored in the memory 230, and determine the number of reception antennas based on the comparison result.

In an example case in which the SE candidates included in the SE set stored in the memory 230 correspond to the number of reception antennas and a rank, the reception antenna determination module may determine the numbers of reception antennas for respective ranks. In an example case in which the maximum rank is 4, the reception antenna determination module may determine the number of reception antennas corresponding to rank 1, the number of reception antennas corresponding to rank 2, the number of reception antennas corresponding to rank 3, and the number of reception antennas corresponding to rank 4. In this case, the processor 210 may determine a final number of reception antennas among the numbers of reception antennas for respective ranks, based on the rank assigned from the BS.

In another example, the processor 210 may compare, by using the reception antenna determination module, the stored SE set with the required SE based on the rank assigned from the BS, and may determine the number of reception antennas according to a comparison result.

The process of comparing the required SE with the SE set will be described below with reference to FIGS. 4A and 4B.

Referring to FIG. 4A, the SE set may include an SE candidate Rx-1 corresponding to one reception antenna, an SE candidate Rx-2 corresponding to two reception antennas, an SE candidate Rx-3 corresponding to three reception antennas, and an SE candidate Rx-4 corresponding to four reception antennas.

As shown in FIG. 4A, among the SE candidate Rx-1, the SE candidate Rx-2, the SE candidate Rx-3, and the SE candidate Rx-4, the SE candidate Rx-2, the SE candidate Rx-3, and the SE candidate Rx-4 may be higher than the required SE. The required SE may indicate an SE required for the current service of the UE, and an SE candidate higher than the required SE may indicate an SE that may satisfy the current service. Although the SE candidate Rx-2, the SE candidate Rx-3, and the SE candidate Rx-4 are higher than the required SE, because using fewer reception antennas may reduce power consumption, the SE candidate Rx-2 may be output as a comparison result. In this case, the processor 210 may determine the number of reception antennas to be 2, according to the comparison result.

According to an embodiment, the processor 210 may output, as a comparison result, SE candidates for respective ranks which satisfy the required SE. Next, the processor 210 may determine a final SE candidate based on the rank assigned from the BS, and may determine the number of reception antennas according to the determined final SE candidate.

Referring to FIG. 4B, the required SE and SE candidates for respective Rx(s) change over time. The SE candidates for respective Rx(s) shown in FIG. 4B may represent the numbers of reception antennas of 1 to 7, from bottom to top, respectively. As shown in FIG. 4B, even in an example case in which the required SE is constant for a certain period (e.g., a first period), because the communication environment changes over time, values of the SE candidates for respective numbers of reception antennas may change. For example, in the first period where the required SE is constant, the numbers of reception antennas may be selected as 4, 2, and 4. After the certain period has elapsed, the required SE changes, and to reflect the change in the required SE, the numbers of reception antennas may be selected as 4 and 5.

According to an embodiment, power consumption may be reduced by performing communication with the BS by using an optimal reception antenna that satisfies a service of the UE 20. In particular, power consumption may be reduced by determining an appropriate number of reception antennas in consideration of the communication environment that changes over time.

FIG. 5 is a diagram illustrating an AI model according to another embodiment.

Referring to FIG. 5, the processor 210 may obtain reference signal information from a received message, and may input the reference signal information into the AI model. The reference signal information may include, but is not limited to, information on at least one of a channel state information reference signal (CSI-RS), a demodulation reference signal (DMRS), and a tracking reference signal (TRS). Also, the reference signal information may include an SINR, MIMO capacity, and the like.

According to another embodiment, the processor 210 may generate SE candidates based on the input reference signal information by using the AI model, and may update the SE candidates stored in the memory 230 by using the generated SE candidates. According to an embodiment, link quality between the UE and the BS may vary over time. The processor 210 may update, by using the AI model, the SE candidates according to the current number of reception antennas of the UE based on the reference signal information obtained from the received message. For example, by updating the SE candidates to reflect link quality that changes over time, communication quality may be guaranteed while reducing the power consumption of the UE.

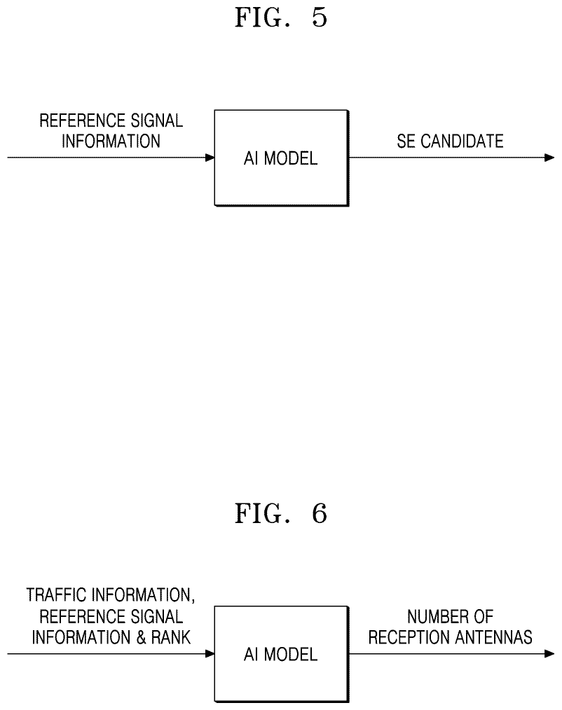

FIG. 6 is a diagram illustrating an AI model according to another embodiment.

Referring to FIG. 6, the processor 210 may obtain traffic information, reference signal information, and a rank from a received message, and may input the obtained traffic information, reference signal information, and rank into the AI model.

Here, the rank obtained from the received message may represent the rank assigned by the BS, and the SE set stored in the memory 230 may include SE candidates corresponding to the number of reception antennas and the rank. In an example case in which the assigned rank is 2 and the number of reception antennas is 4, the SE set may include an SE candidate corresponding to the rank of 2 and the number of reception antennas of 2, an SE candidate corresponding to the rank of 2 and the number of reception antennas of 3, and an SE candidate corresponding to the rank of 2 and the number of reception antennas of 4.

The processor 210 may determine the number of reception antennas based on the obtained traffic information, reference signal information, and rank by using the AI model. For example, the processor 210 may calculate a required SE based on the obtained traffic information by using the AI model, and may update the SE candidates included in the SE set by using the obtained reference signal information. Next, the processor 210 may compare the rank and the required SE with the updated SE candidates, and may determine the number of reception antennas based on a comparison result. Although the processor 210 is described as calculating an SE and comparing the rank and the calculated SE with the SE set, the disclosure is not limited thereto. The processes of calculating the SE and comparing the calculated SE with the SE set are not necessarily executed in order, and the obtained traffic information, reference signal information, and rank may be input to the AI model in the form of a vector to determine the number of reception antennas.

FIG. 7 is a diagram illustrating fields included in UAI, according to an embodiment.

Referring to FIG. 7, the UAI may include at least one field among fields A to G. For example, field A may represent a field for configuring DRX parameters, and may be used to configure DRX parameters such as a DRX period length and a DRX deactivation timer. For example, field B may represent a field for configuring the maximum total bandwidth, and may be used to configure the maximum bandwidth that the UE may use. For example, field C may represent a field for configuring the maximum number of component carriers, and may be used to configure the maximum number of carriers that the UE may activate. For example, field D may represent a field for configuring the maximum number of MIMO layers, and field E may represent a field for configuring an RRC state. For example, field F may represent a field for configuring an activation state of a secondary cell group, and field G may represent a field for configuring RRM measurements. The disclosure is not limited thereto, and the UAI may also include other fields in addition to and/or different from the fields A to G.

The process of generating the UAI will be described below with reference to FIGS. 8 and 9.

FIG. 8 is a diagram illustrating an AI model according to another embodiment.

Referring to FIG. 8, the processor 210 may obtain traffic information from a received message, and may determine a traffic class based on the obtained traffic information by using the AI model. The traffic class may include a class with low delay and high throughput, a class with low delay and low throughput, a class with high delay and high throughput, and a class with high delay and low throughput.

According to an embodiment, the processor 210 may generate UAI based on the determined traffic class. In an example case in which the determined traffic class corresponds to high throughput or low throughput, the processor 210 may configure at least one of a field for configuring the maximum total bandwidth, a field for configuring the maximum number of component carriers, a field for configuring the maximum number of MIMO layers, and a field for configuring an activation state of a secondary cell group.

In an example case in which the determined traffic class corresponds to high throughput, the processor 210 may execute at least one of an operation of configuring the maximum total bandwidth to be high, an operation of configuring the maximum number of component carriers to be high, an operation of configuring the maximum number of MIMO layers to be high, and an operation of configuring the activation state of the secondary cell group to be enabled. In an example case in which the determined traffic class corresponds to low throughput, the processor 210 may execute at least one of an operation of configuring the maximum total bandwidth to be low, an operation of configuring the maximum number of component carriers to be low, an operation of configuring the maximum number of MIMO layers to be low, and an operation of configuring the activation state of the secondary cell group to be disabled.

According to an embodiment, in an example case in which the determined traffic class corresponds to high delay or low delay, the processor 210 may configure at least one of a field for configuring DRX parameters, a field for configuring an RRC state, and a field for configuring RRM measurements.

In an example case in which the traffic class corresponds to high delay, the processor 210 may execute at least one of an operation of configuring a DRX period length to be long, an operation of configuring a DRX deactivation timer to be long, an operation of configuring the RRC state to an idle state, and an operation of configuring the RRM measurements to be simplified. In an example case in which the traffic class corresponds to low delay, the processor 210 may execute at least one of an operation of configuring a DRX period length to be short, an operation of configuring a DRX deactivation timer to be short, an operation of configuring the RRC state to a connected state, and an operation of configuring the RRM measurements to be maintained.

The above-described configuring operations may be accomplished by configuring the fields representing the corresponding functions.

The processor 210 may notify the BS of a UAI reporting function, and may transmit an RRC message including the generated UAI to the BS. The processor 210 may transmit the UAI to the BS, may start a timer, and when the timer expires, may transmit the UAI to the BS again. The above-described timer may be ProhibitTimer defined in 3GPP Rel-15.

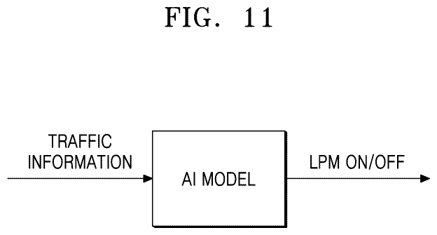

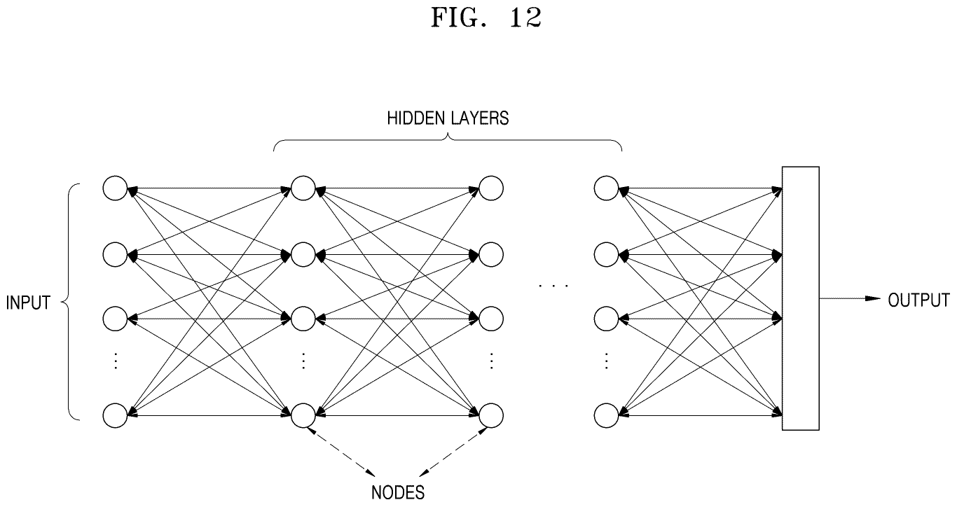

According to another embodiment, when the determined traffic class corresponds to a class with high delay and low throughput, the processor 210 may enter a low power mode (LPM), and thus, the processor 210 may reduce power consumed for signal processing. Here, the LPM may represent a mode in which the processor 210 operates at low power. For example, the processor 210 may execute at least one of an operation of reducing the number of decoding iterations, an operation of reducing the complexity of a detection operation, and an operation of lowering a clock frequency and a supply voltage. An operation of reducing power consumed for signal processing will be described below with reference to FIG. 11.

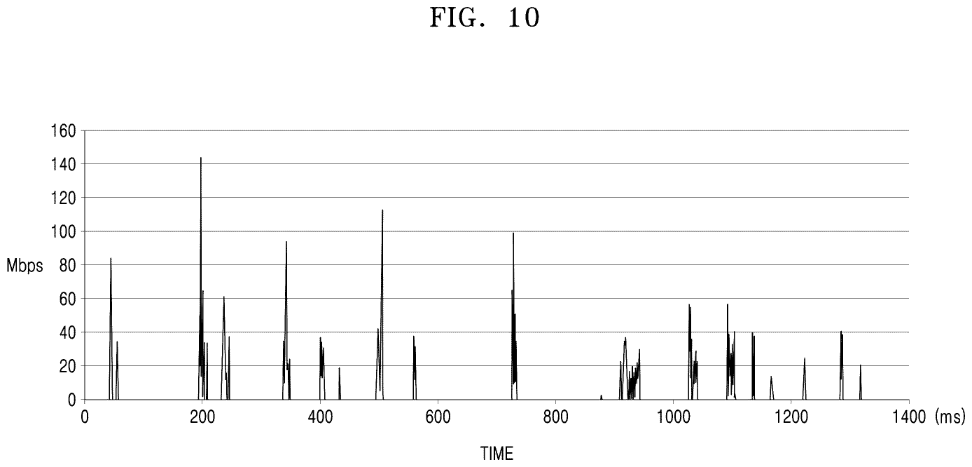

FIG. 9 is a diagram illustrating an AI model according to another embodiment. FIG. 10 is a diagram illustrating a data burst pattern according to an embodiment.

Referring to FIG. 9, the processor 210 may determine at least one of a traffic arrival time and a traffic packet size, based on the obtained traffic information and a prediction time by using the AI model. The processor 210 may configure the prediction time, and may generate UAI of the prediction time based on the determined at least one of the traffic arrival time and the traffic packet size.

According to an embodiment, the processor 210 may generate the UAI of the prediction time to correspond to low delay or high delay. For example, the processor 210 may generate the UAI of the prediction time to correspond to low delay or high delay based on the difference between the determined traffic arrival time and the current time. In this case, the processor 210 may configure at least one of a field for configuring DRX parameters, a field for configuring an RRC state, and a field for configuring RRM measurements, which are included in the UAI of the prediction time.

For example, the processor 210 may compare the difference between the determined traffic arrival time and the current time with a threshold time to determine whether the UAI of the prediction time corresponds to low delay or high delay. In an example case in which the difference between the determined traffic arrival time and the current time is less than the threshold time, the processor 210 may execute, in correspondence to low delay, at least one of an operation of configuring a DRX period length to be short, an operation of configuring a DRX deactivation timer to be short, an operation of configuring the RRC state to a connected state, and an operation of configuring the RRM measurements to be maintained.

In an example case in which the difference between the determined traffic arrival time and the current time is greater than or equal to the threshold time, the processor 210 may execute, in correspondence to high delay, at least one of an operation of configuring a DRX period length to be long, an operation of configuring a DRX deactivation timer to be long, an operation of configuring the RRC state to an idle state, and an operation of configuring the RRM measurements to be simplified.

According to another embodiment, the processor 210 may configure the UAI of the prediction time to correspond to low throughput or high throughput. For example, the processor 210 may configure the UAI of the prediction time to correspond to low throughput or high throughput based on the determined traffic packet size. In this case, the processor 210 may configure at least one of a field for configuring the maximum total bandwidth, a field for configuring the maximum number of component carriers, a field for configuring the maximum number of MIMO layers, and a field for configuring an activation state of a secondary cell group, which are included in the UAI of the prediction time.

For example, the processor 210 may compare the determined traffic packet size with a threshold packet size to determine whether the UAI of the prediction time corresponds to low throughput or high throughput. When the determined traffic packet size is less than the threshold packet size, the processor 210 may execute, in correspondence to low throughput, at least one of an operation of configuring the maximum total bandwidth to be low, an operation of configuring the maximum number of component carriers to be low, an operation of configuring the maximum number of MIMO layers to be low, and an operation of configuring the activation state of the secondary cell group to be disabled.

In an example case in which the determined traffic packet size is greater than or equal to the threshold packet size, the processor 210 may execute, in correspondence to high throughput, at least one of an operation of configuring the maximum total bandwidth to be high, an operation of configuring the maximum number of component carriers to be high, an operation of configuring the maximum number of MIMO layers to be high, and an operation of configuring the activation state of the secondary cell group to be enabled.

The processor 210 may generate UAI of the prediction time and transmit the generated UAI to the BS, thereby reducing the power consumption of the UE while maintaining communication quality. In an example case in which the processor 210 executes a streaming playback application, power consumption may be reduced by transmitting the UAI of the prediction time to the BS.

Referring to FIG. 10, in an example case in which the processor 210 executes a real time application such as a streaming playback application, the throughput is displayed discretely over time. The processor 210 may determine the time and/or the size of throughput for which high throughput is required, and may generate UAI of the prediction time based on the time and/or the size of throughput for which high throughput is required. By transmitting the generated UAI to the BS, the power consumption of the UE may be reduced while maintaining communication quality.

FIG. 11 is a diagram illustrating an AI model according to another embodiment.

Referring to FIG. 11, the processor 210 may obtain traffic information from a received message, and may input the obtained traffic information into the AI model. An output result of the AI model may indicate whether to enter a LPM. The processor 210 may determine whether to enter the LPM based on the output result of the AI model. In an example case in which the processor 210 enters the LPM, power consumed for signal processing may be reduced.

According to an embodiment, the processor 210 may execute at least one of an operation of reducing the number of decoding iterations, an operation of reducing the complexity of a detection operation, and an operation of lowering a clock frequency and a supply voltage. For example, the processor 210 may use a minimum mean square error (MMSE) detector, which consumes low power, when entering the LPM, or may use a maximum likelihood (ML) detector when not entering the LPM. For example, when the processor 210 enters the LPM, the MMSE detector may be used instead of the ML detector.

By using the AI model to determine whether to enter the LPM, the power consumption of the UE may be reduced.

FIG. 12 is a diagram illustrating the structure of a neural network according to an embodiment.

The structure of the neural network shown in FIG. 12 may include a multilayer perceptron (MLP), a convolutional neural network (CNN), a recurrent neural network (RNN), a transformer, a long short-term memory (LSTM), and the like.

An input value of the neural network may include at least one of traffic information, reference signal information, and a rank. The input value may be a currently detected or determined value, or may be a processed value that has undergone preprocessing such as filtering. An output value of the neural network may include at least one of the number of reception antennas, a SE candidate, a required SE, a delay value, and whether to enter a LPM (LPM ON/OFF).

A plurality of hidden layers may be included between an input layer and an output layer of the neural network, and each hidden layer among the plurality of hidden layers may include a plurality of nodes. Each hidden layer may correspond to one function. The neural network shown in FIG. 12 may be trained by both online training and offline training. Online training indicates training a neural network model for use by using data that is measured in real time in the UE. Offline training indicates training the neural network model for use by using previously collected data and then installing the trained neural network model in the UE.

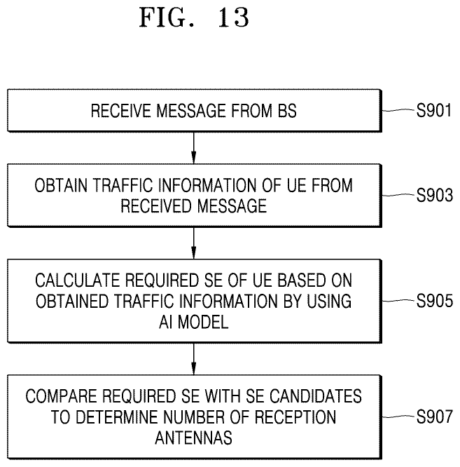

FIG. 13 is a flowchart illustrating a method of determining the number of reception antennas, according to an embodiment.

Referring to FIG. 13, in operation S901, the method may include receiving a message from a base station (BS). For example, the UE 20 may receive a message from a BS. In operation S903, the method may include obtaining traffic information of the UE 20 from the received message. For example, the UE 20 may obtain traffic information of the UE 20 from the received message. In operation S905, the method may include obtaining a required SE of the UE 20 based on the obtained traffic information. For example, the UE 20 may calculate a required SE of the UE 20 based on the obtained traffic information by using an AI model. In operation S907, the method may include comparing the required SE with SE candidates to determine the number of reception antennas. For example, the UE 20 may compare the required SE with SE candidates to determine the number of reception antennas.

According to an embodiment, in operation S905, the UE 20 may update the SE candidates based on reference signal information by using the AI model. In another example, the SE candidates may correspond to the number and reception antennas and a rank.

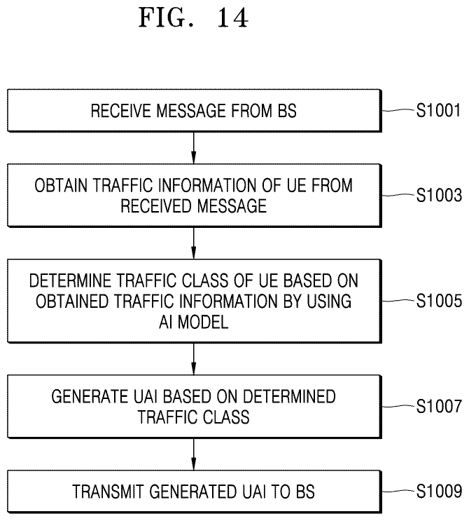

FIG. 14 is a flowchart illustrating a method of generating UAI, according to an embodiment.

Referring to FIG. 14, operations S1001 and S1003 may be same or similar to operations S901 and S903 in FIG. 13, respectively, and thus, descriptions thereof are omitted.

In operation S1005, the method may include determining a traffic class of the UE 20 based on the obtained traffic information. For example, the UE 20 may determine a traffic class of the UE 20 based on the obtained traffic information by using the AI model. The traffic class may include a class with low delay and high throughput, a class with low delay and low throughput, a class with high delay and high throughput, and a class with high delay and low throughput.

In operation S1007, the method may include generating UAI based on the determined traffic class. For example, the UE 20 may generate UAI based on the determined traffic class. In operation S1009, the method may include transmitting the generated UAI. For example, the UE 20 may transmit the generated UAI to the BS.

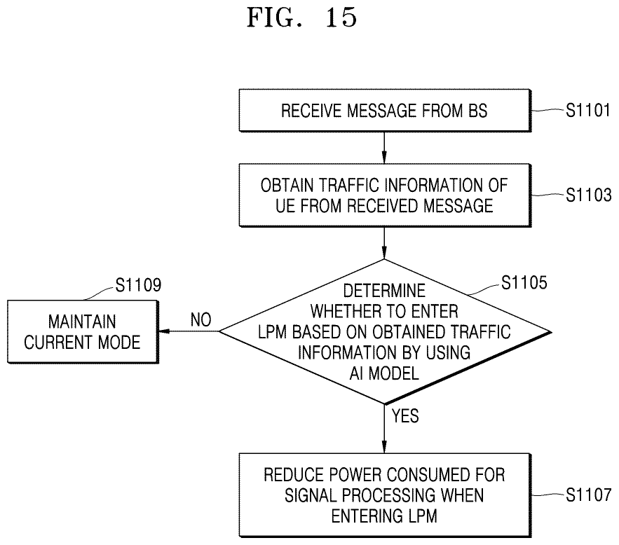

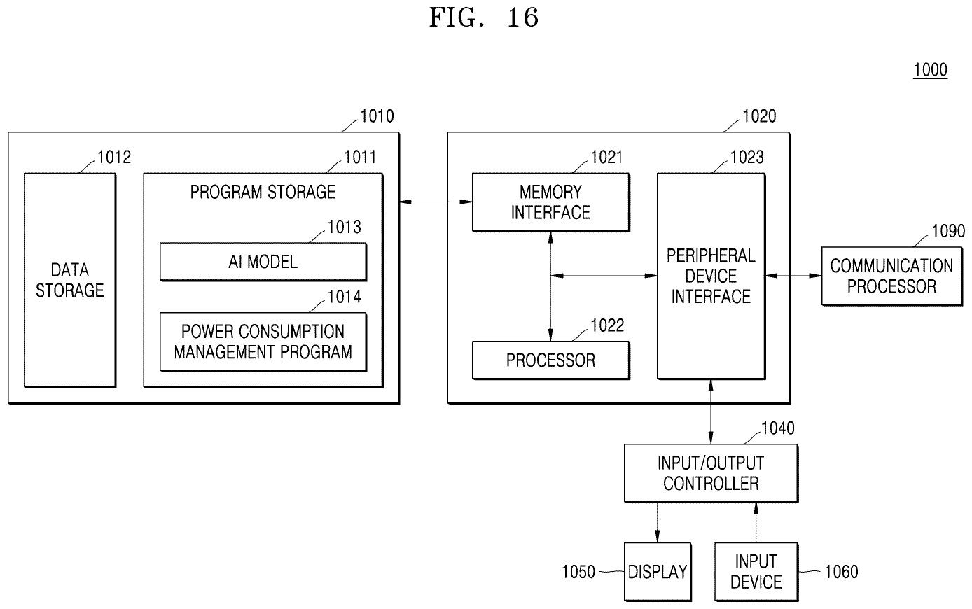

FIG. 15 is a flowchart illustrating a method of executing a LPM, according to an embodiment.

Referring to FIG. 15, operations S1101 and S1103 may be same or similar to operations S901 and S903 in FIG. 13, respectively, and thus, descriptions thereof are omitted.

In operation S1105, the method may include determining whether to enter a LPM based on the obtained traffic information. For example, the UE 20 may determine whether to enter a LPM based on the obtained traffic information by using the AI model.

In an example case in which the UE 20 enters the LPM, in operation S1107, the method may include reducing power consumed for signal processing. For example, the UE 20 may reduce power consumed for signal processing. For example, the UE 20 may execute at least one of an operation of reducing the number of decoding iterations, an operation of reducing the complexity of a detection operation, and an operation of lowering a clock frequency and a supply voltage. After the UE 20 enters the LPM, when the transmission rate increases or the channel environment deteriorates, the UE 20 may stop the LPM.

In an example case in which the UE 20 does not enter the LPM, in operation S1109, the UE 20 may maintain the mode that is currently being executed.

FIG. 16 is a block diagram illustrating a UE 1000 according to another embodiment. Referring to FIG. 16, the UE 1000 may include a memory 1010, a processor unit 1020, an input/output controller 1040, a display 1050, an input device 1060, and a communication processor 1090. According to an embodiment, the memory 1010 may include a plurality of memories.

The memory 1010 may include a program storage 1011 that stores a program for controlling an operation of the UE 1000, and a data storage 1012 that stores data generated during execution of the program. The data storage 1012 may store data required for operations of an AI model 1013 and a power consumption management program 1014. The program storage 1011 may include the AI model 1013 and the power consumption management program 1014. Here, the program included in the program storage 1011 may be a set of instructions, and thus may be expressed as an instruction set.

According to an embodiment, the AI model 1013 may output the number of reception antennas, a traffic class, or whether to enter a LPM, based on traffic information or the like. According to an embodiment, the power consumption management program 1014 may manage the power consumption of the UE 1000 based on an output value of the AI model 1013. For example, the power consumption management program 1014 may generate UAI according to the output traffic class.

According to an embodiment, the processor unit 1020 may include a peripheral device interface 1023, a processor 1022 and a memory interface 1021. The peripheral device interface 1023 may control connection between an input/output peripheral device of a BS, and a processor 1022 and a memory interface 1021. The processor 1022 controls the BS to provide a corresponding service by using at least one software program. Here, the processor 1022 may execute at least one program stored in the memory 1010 to provide a service corresponding to the program.

The input/output controller 1040 may provide an interface between an input/output device, such as the display 1050 and the input device 1060, and the peripheral device interface 1023. The display 1050 displays state information, an input character, a moving picture, a still picture, and the like. For example, the display 1050 may display information about an application program driven by the processor 1022.

The input device 1060 may provide input data generated by selection of the UE 1000, to the processor unit 1020 through the input/output controller 1040. Here, the input device 1060 may include a keypad including at least one hardware button, a touch pad for detecting touch information, and the like. For example, the input device 1060 may provide touch information, such as touch, touch movement, or touch release detected through the touch pad, to the processor 1022 through the input/output controller 1040. The UE 1000 may include the communication processor 1090 that performs a communication function for voice communication and data communication.

While the inventive concept has been particularly shown and described with reference to embodiments thereof, it will be understood that various changes in form and details may be made therein without departing from the spirit and scope of the following claims.

What is claimed is:

1. A user equipment comprising:
a radio frequency (RF) circuit configured to receive a message from a base station;
a memory storing a spectral efficiency set, the spectral efficiency set comprising spectral efficiency candidates corresponding to a number of reception antennas; and
a processor configured to:
obtain traffic information from the message,
calculate a required spectral efficiency based on the traffic information by using an artificial intelligence model,
compare the required spectral efficiency with the spectral efficiency set, and
determine a first spectral efficiency candidate with a first number of reception antennas according to a result of comparing the required spectral efficiency with the spectral efficiency set.

2. The user equipment of claim 1, wherein the spectral efficiency set comprises the spectral efficiency candidates corresponding to the number of reception antennas and a rank, and
the processor is further configured to:
obtain a first rank from the message, and
compare the first rank and the required spectral efficiency with the spectral efficiency set.

3. The user equipment of claim 1, wherein the result comprises a smallest spectral efficiency candidate among one or more of the spectral efficiency candidates that are greater than the required spectral efficiency.

4. The user equipment of claim 1, wherein the traffic information comprises at least one of a packet size, a packet arrival interval, a number of packets, a transport packet size, a modulation and coding scheme, or a number of resource blocks.

5. The user equipment of claim 1, wherein the processor is further configured to:
obtain reference signal information from the message,
generate one or more new spectral efficiency candidates based on the reference signal information by using the artificial intelligence model, and
update the spectral efficiency candidates stored in the memory by using the one or more new spectral efficiency candidates, and
wherein the reference signal information comprises information on at least one of a channel state information reference signal (CSI-RS), a demodulation reference signal (DMRS), or a tracking reference signal (TRS).

6. The user equipment of claim 1, wherein the processor is further configured to:
determine a delay value based on the traffic information by using the artificial intelligence model,
determine a traffic class based on the required spectral efficiency and the delay value, and
generate user equipment assistance information (UAI) based on the traffic class.

7. The user equipment of claim 6, wherein the processor is further configured to:
notify the base station of a UAI reporting function, and
transmit a radio resource control (RRC) message comprising the UAI to the base station.

8. The user equipment of claim 6, wherein the processor is further configured to:
determine at least one of a traffic arrival time and a traffic packet size, based on the traffic information and a prediction time by using the artificial intelligence model, and
generate UAI of the prediction time based on the determined at least one of the traffic arrival time and the traffic packet size.

9. The user equipment of claim 1, wherein the processor is further configured to:
determine whether to enter a low power mode, based on the traffic information by using the artificial intelligence model, and
based on a determination to enter the low power mode, reduce power consumed for signal processing.

10. The user equipment of claim 9, wherein the processor is further configured to, based on the determination to enter the low power mode, perform at least one of an operation of reducing a number of decoding iterations and an operation of lowering a clock frequency and a supply voltage.

11. A user equipment comprising:
a radio frequency (RF) circuit configured to receive a message from a base station; and
a processor configured to:
obtain traffic information of the user equipment from the message,
determine a traffic class based on the traffic information by using an artificial intelligence model, and
generate user equipment assistance information (UAI) based on the traffic class.

12. The user equipment of claim 11, wherein the traffic class comprises a class with low delay and high throughput, a class with low delay and low throughput, a class with high delay and high throughput, and a class with high delay and low throughput.

13. The user equipment of claim 12, wherein the UAI comprises at least one of a field for configuring discontinuous reception (DRX) parameters, a field for configuring a maximum total bandwidth, a field for configuring a maximum number of secondary carriers, a field for configuring a maximum number of multiple-input multiple-output (MIMO) layers, a field for configuring a radio resource control (RRC) state, a field for configuring an activation state of a secondary cell group, or a field for configuring radio resource management (RRM) measurements.

14. The user equipment of claim 13, wherein the processor is further configured to:
based on the traffic class corresponding to high throughput or low throughput, configure at least one of the field for configuring the maximum total bandwidth, the field for configuring the maximum number of secondary carriers, the field for configuring the maximum number of MIMO layers, and the field for configuring the activation state of the secondary cell group; and
based on the traffic class corresponding to high delay or low delay, configure at least one of the field for configuring the DRX parameters, the field for configuring the RRC state, and the field for configuring the RRM measurements.

15. The user equipment of claim 12, wherein the processor is further configured to:
notify the base station of a UAI reporting function, and
transmit a radio resource control (RRC) message comprising the UAI to the base station.

16. The user equipment of claim 12, wherein the processor is further configured to:
determine at least one of a traffic arrival time and a traffic packet size, based on the traffic information and a prediction time by using the artificial intelligence model, and
generate UAI of the prediction time based on the determined at least one of the traffic arrival time and the traffic packet size.

17. The user equipment of claim 12, wherein the processor is further configured to, based on the traffic class comprising the class with high delay and low throughput, enter a low power mode and reduce power consumed for signal processing.

18. The user equipment of claim 17, wherein the processor is further configured to, after entering the low power mode, perform at least one of an operation of reducing a number of decoding iterations and an operation of lowering a clock frequency and a supply voltage.

19. A communication system comprising:
a base station; and
a user equipment configured to:
receive a message from the base station,
obtain traffic information from the message,
determine a traffic class based on the traffic information by using an artificial intelligence model, and
generate user equipment assistance information (UAI) based on the traffic class.

20. The communication system of claim 19, wherein the user equipment is further configured to:
notify the base station of a UAI reporting function, and
transmit a radio resource control (RRC) message comprising the UAI to the base station.
